(19) United States
(12) Patent Application Publication
(10) Pub. No.: US 2004/0189135 A1
(43) Pub. Date: Sep. 30, 2004

(54) Motor stator for a home electric fan

(75) Inventor: Chao-Chin Chung, Taoyuan (TW)

Correspondence Address: BACON & THOMAS, PLLC, 625 SLATERS LANE, FOURTH FLOOR, ALEXANDRIA, VA, 22314

(73) Assignee: Kuen Yang Industrial Co., Ltd., Taoyuan Hsien (TW)

(21) Appl. No.: 10/397,204

(22) Filed: Mar. 27, 2003

(51) Int. Cl. H02K 1/00

(52) U.S. Cl. 310/216

(57) ABSTRACT

The motor stator of an electric fan is made of a plurality of silicon steel slices piled up and fixedly compressed together. Each silicon steel slice is bored with an insert hole in the center for a motor rotor to be inserted therein. The insert hole has its circumferential wall bored with a plurality of recessed wire grooves for a coil to be wound therein. The silicon steel slice is 60±1 mm in length and in width, and the diameter of the insert hole is 33±1 mm. The insert hole has its circumferential wall bored with 16 recessed wire grooves. Thus, the coil is wound around the wire grooves to form a four-electrode motor stator, able to increase the magnetic current and the torsion of a motor.

### BACKGROUND OF THE INVENTION

1. Field of the Invention

This invention relates to a motor stator for a home electric fan, particularly to one able to increase the torsion and the output power of the motor under the condition of neither changing the amount of material nor increasing producing cost.

2. Description of the Prior Art

A conventional electric fan or ventilator or air cooler is provided with a mouse cage-shaped rotor motor as a power source. The stator of such a rotor motor is commonly classified into two specifications: 75 mm and 60 mm, only these two different-sized stators are extremely similar in structure. Generally, the foresaid stator is made of a plurality of silicon steel plates laminated and fixedly compressed together, with each silicon steel plate having a fixed length and width and bored with an insert hole in the center for receiving a motor rotor therein. The central insert hole of the silicon steel plate has its circumferential wall bored with a plurality of recessed wire grooves for a coil to be wound therein.

However, in practical use, it is found that the 75 mm-sized stator has drawbacks of power loss and temperature rising because the effect of coil resistance and copper loss need to be taken into consideration. A U.S. patent application Ser. No. 09/527884 titled “IMPROEMENT ON THE MOTOR STATOR FOR AN ELECTRIC FAN”, which was designed to solve the problems of copper loss and temperature rising of the 75 mm-sized motor stator.

The 60 mm-sized motor stator has been found to have some problems, having the same structure as that of the 75 mm-sized motor stator, is bored with only 8 or 12 wire grooves at the circumferential wall of the central insert hole of the silicon steel plates for a coil to be wound therein, therefore the coil wound around the stator can only make a two-electrode motor, consequently affecting the magnetic current of the motor and resulting in low motor torsion and motor output power.

### SUMMARY OF THE INVENTION

The objective of the invention is to offer a motor stator for an electric fan, able to reduce power consumption, increase motor torsion and enhance motor output power.

The motor stator in the present invention is made of a plurality of silicon steel plates laminated and fixedly compressed together. Each silicon steel plate is formed with an insert hole in the center for receiving a motor rotor therein, and the central insert hole of the silicon steel plate has its circumferential wall bored with a plurality of recessed wire grooves for a coil to be wound therein.

The feature of the invention is that each silicon steel plate is 60±1 mm both in length and in width, and the diameter of the central insert hole is 33±1 mm, and the central insert hole has its circumferential wall bored equidistantly with 16 recessed wire grooves, able to make up a four-electrode motor stator to increase the number of wire grooves and poles and the magnetic current and torsion of the motor after the stator is wound with a coil.

### BRIEF DESCRIPTION OF DRAWINGS

This invention will be better understood by referring to the accompanying drawings, wherein:

FIG. 1 is a cross-sectional view of a first embodiment of a motor stator and a motor rotor separated from each other in the present invention:

FIG. 2 is a cross-sectional view of the first embodiment of the motor stator and the motor rotor combined together in the present invention:

FIG. 3 is a cross-sectional view of a second embodiment of a motor stator and a motor rotor separated from each other in the present invention: and

FIG. 4 is a cross-sectional view of the second embodiment of the motor stator and the motor rotor combined together in the present invention.

Enclosed: A photocopy of a U.S. patent application Ser. No. 09/527884.

### DETAILED DESCRIPTION OF THE PREFERRED EMBODIMENT

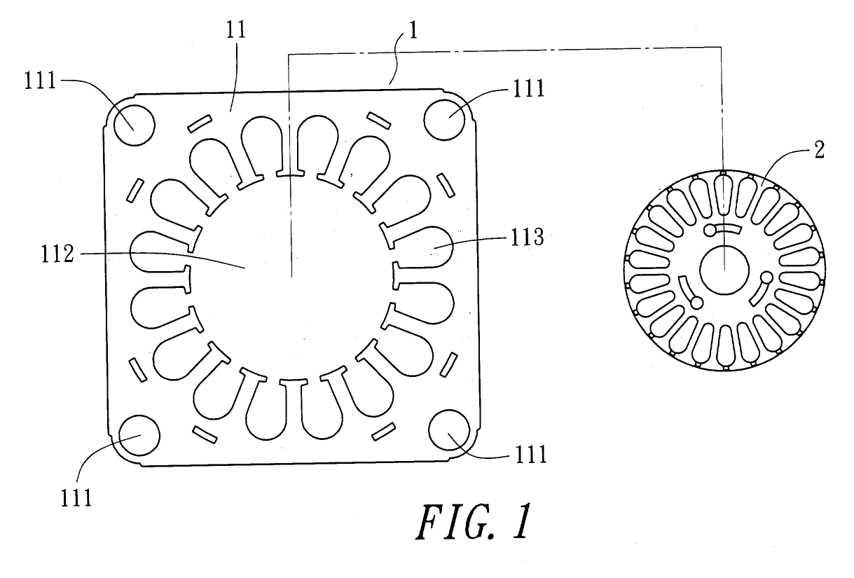

A first preferred embodiment of a motor stator for a home electric fan in the present invention, as shown in FIG. 1, includes a plurality of silicon steel plates 11, which are respectively 60±1 mm both in length and in width and laminated and fixedly compressed together.

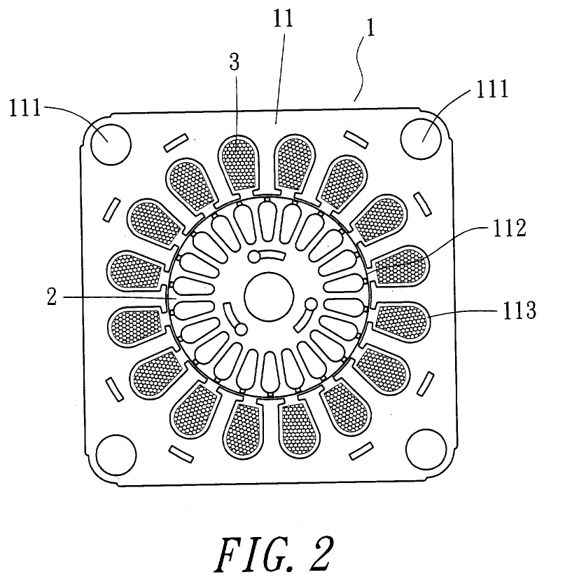

Each silicon steel plate has its four corners respectively bored with a combining hole 111, so that the silicon steel plates 11 can be fixedly combined with the shell of a motor. The silicon steel slice 11 is bored in the center with an insert hole 112 having a diameter of 33±1 mm for a rotor 2 to be positioned therein. The insert hole 112 has its circumferential wall bored equidistantly with 16 recessed wire grooves 113 for a coil 3 to be wound therein, as shown in FIG. 2.

FIG. 2 shows the combination of the motor stator 1, the rotor 2 and the coil 3. The rotor 2 is positioned in the central insert hole 112 of the motor stator 1, with a proper gap maintained between the rotor 2 and the circumferential wall of the insert hole 112. The coil 3 is wound around the wire grooves 113 in a four-electrode winding mode to make up a four-electrode motor.

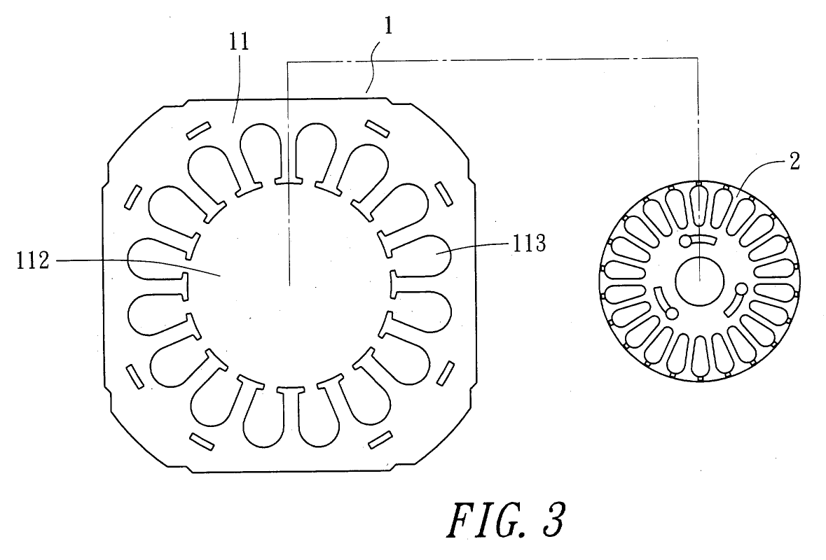

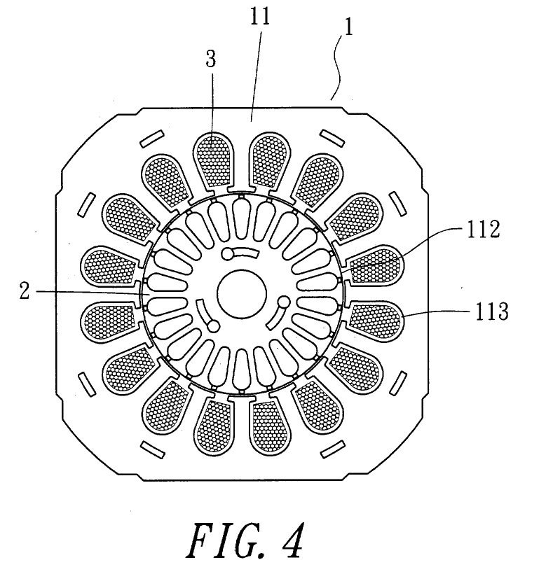

A second embodiment of a motor stator for a home electric fan, as shown in FIGS. 3 and 4, includes a plurality of silicon steel plates 11 laminated and fixedly compressed together. The stator 1 is combined with the rotor 2 and the coil 3. Different from the silicon steel plate 11 in the first preferred embodiment, the silicon steel plate 11 in the second preferred embodiment has its four corners respectively cut into an arc and is provided with no combining holes, so that the stator 1 can have its silicon steel slices 11 with arc-shaped corners inserted and fixed in the shell of the motor in case fixation by inserting is available.

As can be noted from the above description, this invention has the following advantages.

1. The silicon steel plates 1 employed to make a motor stator in the present invention are the same as the conventional ones in size and specifications, in other words, the motor stator of this invention is made without changing the amount of silicon steel plates and increasing producing cost.

2. The number of motor electrodes is increased by increasing the number of the wire grooves 113, able to enhance the magnetic current and the output torsion of the motor and reduce power loss.

While the preferred embodiments of the invention have been described above, it will be recognized and understood that various modifications may be made therein and the appended claims are intended to cover all such modifications that may fall within the spirit and scope of the invention.

I claim:

1. A motor stator for a home electric fan comprising a plurality of silicon steel plates laminated and fixedly compressed together, each said silicon steel plate bored with an insert hole in the center for a motor rotor to be inserted therein, said central insert hole having its circumferential wall bored equidistantly with a plurality of recessed wire grooves, said recessed wire grooves provided for a coil to be wound therein, each said silicon steel plate being 60±1 mm both in length and in width, the diameter of said insert hole being 33±1 mm, said central insert hole having its circumferential wall bored equidistantly with 16 recessed grooves, said coil wound around said wire grooves in a four-electrode winding mode to form a four-electrode motor stator, increasing the number of said wire grooves and electrodes able to enhance the magnetic current and the torsion of a motor.
